(19) United States
(12) Patent Application Publication
(10) Pub. No.: US 2008/0180594 A1
(43) Pub. Date: Jul. 31, 2008

(54) TRANSFLECTIVE LCD DISPLAY FOR AIRCRAFT

(76) Inventors: James R. PIERCE, Cumming, GA (US); Eric H. WALKER, Suwanee, GA (US); John A. WAHL, Duluth, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/668,146

(22) Filed: Jan. 29, 2007

(51) Int. Cl. G02F 1/13357

(52) U.S. Cl. 349/61

(57) ABSTRACT

A transflective cockpit display device for aircraft has display electronics and a transflective liquid crystal display (LCD). The backlight lamp of the transflective LCD is brighter than those of common transmissive LCDs to facilitate viewing in the changing light conditions experienced by aircraft.

### BACKGROUND OF THE INVENTION

1. Field of the Invention

The present invention relates generally to electronic displays and, more specifically, to displays used in aircraft.

2. Description of the Related Art

The liquid crystal display (LCD) screen is the most common type of display screen for computing and communication devices in use today. It is particularly suitable for mobile devices, such as laptop computers, personal digital assistants (PDAs) and telephones, because it is generally lighter in weight and more rugged, space-efficient and power-efficient than a display based upon alternative technologies. Nevertheless, LCDs are used in a wide variety of display devices, including those of aircraft and ground vehicles. LCDs are commonly backlit by a lamp built into the display housing to enhance readability in dim light. An LCD that can be backlit is referred to as “transmissive” because the light emitted by the lamp is transmitted through the screen to the viewer's eyes.

Transmissive LCDs are difficult to view in bright sunlight or other bright conditions because bright light tends to produce a washed-out effect or reduced-contrast effect. Fully reflective LCDs that have no backlighting do not suffer from this problem, as they reflect all of the ambient light. Nevertheless, fully reflective LCDs are not used in display devices intended to be used in a variety of light conditions because they cannot be viewed in darkness and dim light.

A compromise solution has been to provide a transmissive LCD with a very bright backlight lamp. Whereas a typical transmissive LCD may have a lamp with a brightness of 200-400 nit (candela per square meter), LCDs having lamp brightnesses on the order of 1,000 nit have been developed for devices intended for use both indoors in dim light and outdoors in bright sunlight. Such super-high-brightness transmissive LCDs are generally bulkier, less economical and less power-efficient than the standard transmissive LCDs used in the vast majority of commercially available display devices. Consequently, their use has largely been confined to military and aerospace applications, such as aircraft instrument panels, where performance is of greater concern than low cost.

LCDs that mix transmitted backlight with reflected ambient light are known as “transflective” (also sometimes referred to as “transreflective”). A transflective LCD that passes or transmits a high percentage of the backlight while reflecting some of the ambient light is a good compromise between a transmissive LCD and a reflective LCD because it is highly readable in both dim and bright light. The brightness of transflective LCDs as measured off the screen in darkness, i.e., due entirely to backlighting, is typically on the order of 200-400 nit, as in a typical consumer-grade transmissive LCD. In fact, some manufacturers have retrofitted or modified commercial-off-the-shelf transmissive LCDs by installing partially reflective, partially transmissive films between the backlight lamp and the LCD. Other methods for making transflective LCDs include thin-film vacuum deposition of a material such as indium-tin oxide directly on the rear of the LCD.

Accordingly, it would be desirable to provide an improved LCD display for use in aircraft. It is to such a display and method of use that the present invention is primarily directed.

### SUMMARY OF THE INVENTION

Briefly described, in a preferred form, the present invention relates to a high-brightness transflective display device for aircraft. The display device has display electronics and a transflective liquid crystal display (LCD) coupled to the display electronics. The backlight lamp of the transflective LCD preferably has a brightness selected such that it causes the display device to have a brightness (as measured in ambient darkness, i.e., brightness due entirely to the backlighting) greater than about 500 nit (candela per square meter), which is much brighter than most commercially available transmissive LCDs. Still more preferably, the LCD has a brightness greater than about 750 nit. The high-brightness transflective display device can be made economically by modifying a commercial-off-the-shelf transmissive LCD display device, adding a transmissive-reflective coating or film, and replacing the backlight lamp with a high-brightness backlight lamp.

The above-described transflective display device can be included in aircraft instruments. The transflective display is easily viewable in aircraft cockpit light conditions ranging from bright sunlight to total darkness. The novel display device of the present invention provides excellent performance without the cost, power consumption and heat generation of very-high-brightness purely transmissive displays.

### BRIEF DESCRIPTION OF THE DRAWINGS

FIG. 1 is a perspective view of a high-brightness transflective display device, according to a preferred illustrative form of the present invention.

FIG. 2 is a cross-sectional view of the high-brightness transflective display device of FIG. 1, taken on line 2-2 of FIG. 1.

FIG. 3 illustrates the high-brightness transflective display device of FIG. 1 in an aircraft instrument mounted in an aircraft instrument panel.

### DETAILED DESCRIPTION

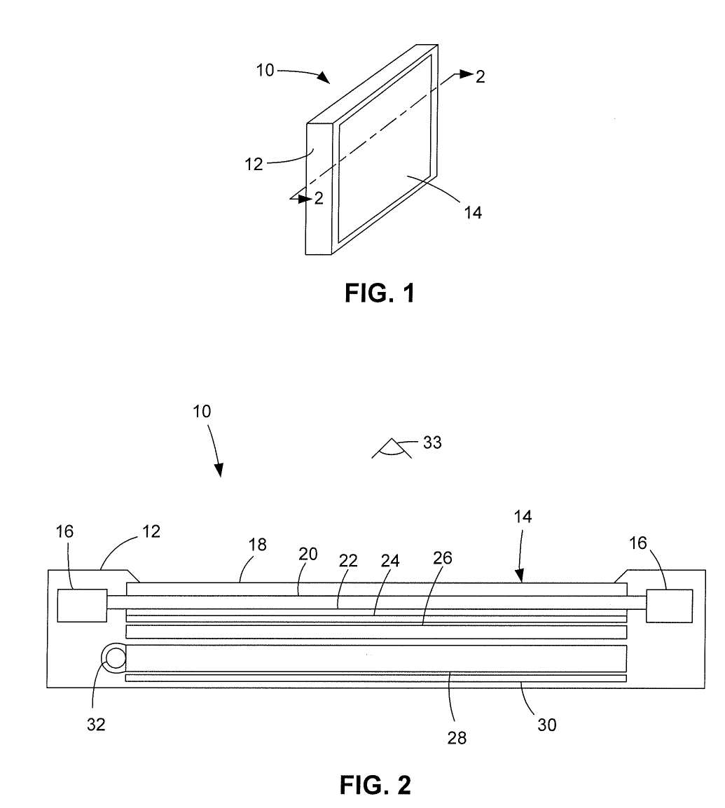

As illustrated in FIGS. 1-2, a high-brightness transflective display device 10 has a shape similar to that of conventional display devices included in laptop computers, flat-screen computer monitors, avionics instruments, and the like. As such, display device 10 includes a relatively thin-profile rectangular housing 12 in which are mounted a transflective liquid crystal display (LCD) 14 and associated display electronics 16.

LCD 14 comprises, in layered arrangement, a cover glass 18, a liquid crystal panel 20, a partially transmissive, partially reflective (transflective) film 22, a brightness-enhancing film 24, a diffuser 26, an edge-lit backlight or light guide 28, and a reflective film 30. Display electronics 16 controls liquid crystal panel 20 by applying electric charges in the conventional manner. In a manner analogous to a one-way mirror, transflective film 22 reflects a portion of the ambient light that may be incident upon cover glass 18 and transmits another portion of that ambient light. A high-brightness backlighting lamp 32, such as a cold cathode fluorescent lamp (CCFL), is optically coupled to light guide 28. The brightness of backlighting lamp 32 causes LCD 14 to have a measurable brightness (as measured off cover glass 18 from an observation point 33 in ambient darkness) greater than about 500 nit (candela per square meter). In an especially preferred form, LCD 14 has a brightness greater than about 750 nit. However, a lamp having a much greater brightness (e.g., greater than about 1,500 nit) may consume excessive power and generate excessive heat. With the exception of the brightness of backlighting lamp 32 and the manner in which it is controlled, the arrangement, structure and function of the individual above-referenced elements shown in FIG. 2 are conventional, well known in the art, and therefore not described in further detail herein.

In addition to controlling liquid crystal panel 20, display electronics 16 controls the brightness of backlighting lamp 32 in response to a signal received from an ambient light sensor 31. Preferably, the brightness of backlighting lamp 32 is maximized when ambient light is neither very bright nor very dim, as would typically occur at dusk and dawn. Still more preferably, in addition to maximizing the brightness of backlighting lamp 32 at dusk and dawn, the brightness of backlighting lamp 32 is minimized when ambient light is low and set to a medium brightness when ambient light is bright. Operating backlighting lamp 32 in this manner conserves power and works synergistically with the transflective properties of LCD 14. In very bright ambient light, display electronics 16 may turn backlighting lamp 32 off entirely.

Transflective LCD 14 can be made economically by modifying a commercial-off-the-shelf (COTS) transmissive LCD device. For example, film 22 or, alternatively, a transmissive-reflective coating (e.g., vacuum-deposited indium-tin oxide, not shown) can be added to the COTS device, and the manufacturer's original backlighting lamp (typically 200-400 nit for a consumer-grade device) can be replaced with the above-described high-brightness backlighting lamp 32.

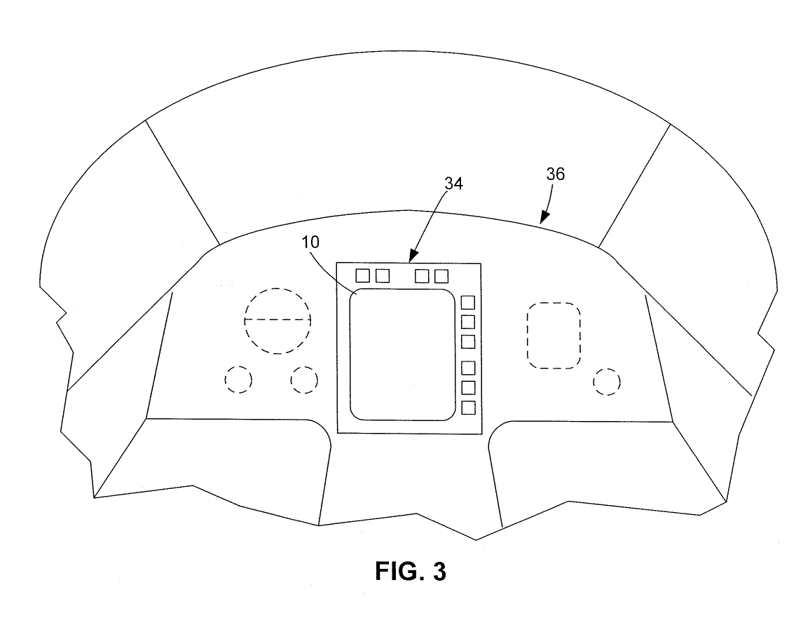

As illustrated in FIG. 3, high-brightness transflective display device 10 can be included in an aircraft instrument 34 mountable in a conventional manner in a cockpit instrument panel 36. Aircraft instrument 34 and its display device 10 and other features can be of any conventional type, shape, size, number, etc., and any such features that may be shown in FIG. 3 are shown for purposes of illustration only. Although shown mounted in instrument panel 36 in the exemplary embodiment of the invention, in other embodiments display device 10 can be mounted in any other suitable location in an aircraft, such as in a passenger cabin.

The unusually bright transflective display device 10 is easily viewable by pilots in the changing light conditions typical of aircraft cockpits. It remains viewable even if part of LCD 14 is in deep shadow and part is in bright sunlight, as often occurs as the aircraft changes attitude with respect to the sun. It also remains viewable during the problematic transition times of day of dusk and dawn.

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. In an aircraft instrument having a liquid crystal display (LCD) device and display electronics, the improvement therein comprising:
the LCD device having a transflective LCD comprising a transmissive-reflective layer and a backlight lamp causing the LCD device to have a brightness of at least about 500 nit, wherein in use in an aircraft cockpit the LCD device has good readability over a wide variety of ambient light conditions.

2. The improvement as claimed in claim 1, wherein the backlight lamp causes the LCD device to have a brightness of at least about 750 nit.

3. The improvement as claimed in claim 1, wherein the backlight lamp causes the LCD device to have a brightness of about 900 nit.

4. The improvement as claimed in claim 1, wherein the improvement further comprises the display electronics including an ambient light sensor for adjusting the brightness in response to ambient light.

5. The improvement as claimed in claim 1, wherein the transflective LCD comprises a consumer-grade transmissive LCD combined with a transmissive-reflective layer and relatively high-brightness backlight lamp.

6. A method for disposing a display device in an aircraft, comprising:
providing a display device having display electronics and a transflective liquid crystal display (LCD) coupled to the display electronics, the LCD having a transmissive-reflective material and a backlight lamp causing the LCD device to have a brightness of at least about 500 nit; and
disposing the display device in an aircraft.

7. The method claimed in claim 6, wherein the disposing step comprises mounting the display device in the aircraft in an orientation viewable by an occupant of the aircraft.

8. The method claimed in claim 6, wherein the backlight lamp causes the display device to have a brightness greater than about 750 nit.

9. The method claimed in claim 6, wherein the backlight lamp causes the display device to have a brightness greater than about 900 nit.
